(19) United States
(12) Patent Application Publication
(10) Pub. No.: US 2007/0034093 A1
(43) Pub. Date: Feb. 15, 2007

(54) Cooking utensil for enhancing or modifying food flavors

(75) Inventor: Janie Ellen Nelson, Lacey, WA (US)

Correspondence Address: John M. Janeway, Suite. 350, 155-108th Avenue N.E., Bellevue, WA, 98004-5973, US

(73) Assignee: Callisons, Inc.

(21) Appl. No.: 11/502,612

(22) Filed: Aug. 9, 2006

Related U.S. Application Data
(60) Provisional application No. 60/708,285, filed on Aug. 9, 2005.

(51) Int. Cl. A47J 37/04

(52) U.S. Cl. 99/419

(57) ABSTRACT

In one aspect of the invention, a skewer for flavoring food includes flavoring that has an essential oil to enhance or modify the flavor of the food. An essential oil is an oil that is volatile, i.e. that rapidly evaporates, and thus can be easily absorbed by many different materials. The skewer also includes a body operable to impale food and that has an absorbent material that includes a surface that contacts the food when the body impales the food. With an essential oil, the flavoring is easily absorbed by the absorbent material and easily migrates to the surface when the food is impaled by the body. Thus, the skewer can release an adequate amount of flavoring more consistently throughout the time that the food cooks or contacts the skewer.

### INCORPORATION BY REFERENCE OF RELATED APPLICATIONS

This application claims priority from commonly owned U.S. Provisional Patent Application No. 60/708,285, filed Aug. 9, 2005, and titled COOKING UTENSIL FOR ENHANCING OR MODIFYING FOOD FLAVORS, presently pending, which is incorporated herein by reference in its entirety and for all its teachings and disclosures.

### BACKGROUND

Many people add flavoring to food to enhance or modify the food's flavor. A common technique for flavoring food is to impale the food with a skewer that contains flavoring and then cook the food and skewer combination. While the food cooks, the skewer holds the food and releases the flavoring that the food then absorbs. When absorbed, the flavoring combines with the food's other flavoring to enhance or modify the food's flavoring. Another example includes placing the food on a plank that contains the flavoring and then cooking the food-on-plank combination. While the food cooks, the flavoring in the plank is released from the plank and absorbed by the food to combine with the food's other flavorings.

The flavoring often used is a salt, a fixed-oil or a combination of the two. Salts are compounds that dissolve in water such as common table salt or sodium chloride. Fixed-oils, such as olive oil, are oils that do not rapidly evaporate, and thus are not volatile.

Unfortunately, flavoring absorbed by a skewer or plank and that is a salt or a fixed-oil is not easily released from the skewer or plank. Thus, when the food is finished cooking, only a small amount of the flavoring has combined with the food's other flavoring to enhance or modify the food's flavoring. A common way to overcome this problem is to dispose much of the flavoring on the surface of the skewer or plank, not inside the skewer or plank, to allow the salt or fixed-oil to be more easily released by the skewer or plank. However, when all of the flavoring is disposed on a surface of the skewer or plank, the skewer or plank often releases the flavoring quicker than the food can absorb it and thus, much of the flavoring evaporates or drips away from the food.

Another way to overcome this problem is to store the flavoring in a cavity inside the skewer or plank and provide holes from the surface of the skewer or plank to the cavity to allow the salt or fixed-oil to be more easily released by the skewer or plank. However, modifying the skewers or planks to include a cavity and holes increases the amount of time, and thus cost, to make such skewers or planks.

### SUMMARY

In one aspect of the invention, a skewer for flavoring food includes flavoring that has an essential oil to enhance or modify the food's flavor. An essential oil is an oil that is volatile, i.e. that rapidly evaporates, and thus can be easily absorbed by many different materials. The skewer also includes a body operable to impale food. The body includes an absorbent material that absorbs and holds the flavoring until it's time to release it to the food. The absorbent material has a surface that, when the body impales the food, contacts the food and establishes an interface between the flavoring held in the absorbent material and the food. Because the flavoring includes an essential oil, the flavoring is easily absorbed by the absorbent material, and easily migrates to the surface when the food is impaled by the body. Thus, the skewer can release an adequate amount flavoring more consistently throughout the time that the food cooks or contacts the skewer.

In another aspect of the invention, a plank for flavoring food includes flavoring that has an essential oil to enhance or modify the food's flavor. The plank also includes a body operable to support food that is placed on the body. The body includes an absorbent material that has a surface that contacts the food when the food is placed on the body.

In another aspect of the invention, a method for flavoring food includes absorbing flavoring that includes an essential oil into absorbent material of a skewer, impaling the food with a body of the skewer, contacting the food with a surface of the absorbent material, and migrating the flavoring to the surface of the absorbent material.

In yet another aspect of the invention, a method for flavoring food includes absorbing flavoring that includes an essential oil into absorbent material of a plank, setting the food on a body of the plank, contacting the food with a surface of the absorbent material, and migrating the flavoring to the surface of the absorbent material.

### BRIEF DESCRIPTION OF THE FIGURES

FIG. 1 is a perspective view of a skewer according to an embodiment of the invention.

FIG. 2 is a cross-sectional view of the skewer in FIG. 1.

FIG. 3 is a cross-sectional view of a skewer according to another embodiment of the invention.

FIG. 4 is a perspective view of a section of the skewer in FIG. 1.

FIG. 5 is a perspective view of a plank according to another embodiment of the invention.

FIG. 6 is a perspective view of a swizzle stick according to yet another embodiment of the invention.

FIG. 7 is a perspective view of a fondue stick according to yet another embodiment of the invention.

### DETAILED DESCRIPTION

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

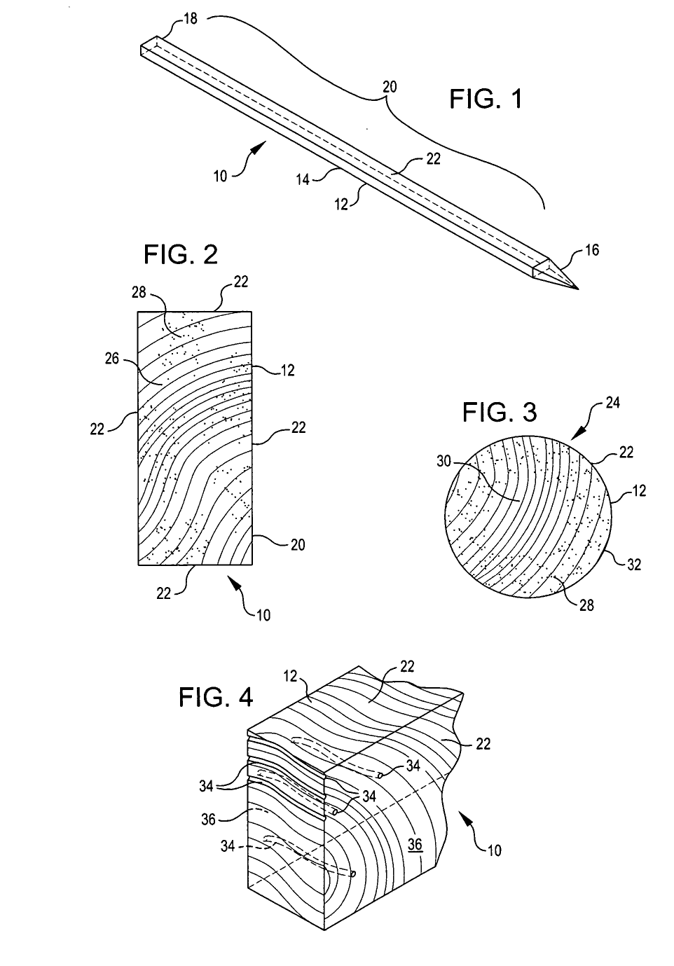

FIG. 1 is a perspective view of a skewer 10 according to an embodiment of the invention. The skewer 10 flavors food (not shown) that it contacts, and holds the food while flavors of the food and skewer combine to enhance the food's flavoring or to generate a different flavor. The skewer 10 may hold food while one cooks the food, or the skewer may hold food that will not be cooked before being eaten, such as fruit. To flavor the food, the skewer 10 includes flavoring (shown in FIGS. 2 and 3, but not here in FIG. 1) that includes an essential oil. An essential oil is an oil that is volatile or that easily evaporates, and thus, may be easily absorbed by an absorbent material 12 of the skewer 10, and, when the skewer 10 contacts the food or is heated, may be easily released by the absorbent material 12 to be absorbed by the food.

The flavoring in the skewer 10 includes at least 20% essential oil, by volume, and any other desired ingredients. For example, in this and certain other embodiments the flavoring includes about 60% essential oil, by weight, and 40% oleoresin, by weight. An oleoresin is a mixture of resin and an oil, which may or may not include an essential oil. An oleoresin may be naturally produced by a plant and subsequently extracted, or an oleoresin may be synthetically made. Oleoresins provide a deeper, full bodied flavor but because they are less soluble that essential oils they are not as easily absorbed and released by the absorbent material 12. In other embodiments, the flavoring includes an essential oil and may also include a syrup and/or a salt, which may be in lieu of an oleoresin or which may be in addition to an oleoresin. In other embodiments, the flavoring may be 100% essential oil, by volume, and may be one type of essential oil or a combination of different types of essential oils.

Still referring to FIG. 1, the skewer 10 also includes a body 14 to impale and hold food. For example, in this and certain other embodiments, the body 14 includes a first end 16 to impale the food, a second end 18, and a main section 20 to hold the food. The main section 20 includes the absorbent material 12, which includes a surface 22 that contacts the food when the section 20 holds the food. When food is held by the skewer 10, the flavoring that was previously absorbed by the absorbent material 12 migrates toward the surface 22. The migration of the flavoring can be caused by any desired mechanism, such as capillary action, heat or both. After the flavor reaches the surface 22, much of the flavoring is absorbed by the food that contacts the surface 22.

The absorbent material 12 may be any desired material that allows the flavoring to readily migrate toward the surface 20. For example, in this and certain other embodiments, the absorbent material 12 may be any desired wood. Some woods more easily allow essential oils to migrate within them than other woods do. But, by orienting fibers of a wood having slow migration properties, to expose them in a large region of the surface 22 (discussed in greater detail in conjunction with FIG. 4), such woods can still perform well. In this and certain other embodiments, the absorbent material 12 is Ash and forms the main section 20 and two ends 16 and 18. Because Ash has a very mild and bland flavor, the flavoring does not need to include ingredients that account for any inherent flavoring of the absorbent material 12. In other embodiments, the absorbent material is birch, which has an inherent, slightly off-note flavor. In still other embodiments, the absorbent material is Poplar, which has an inherent, sweet flavor. In still other embodiments, the absorbent material is Alder, which has an inherent, sour flavor.

Other embodiments are possible. For example, the skewer 10 may include a main section 20 made of a material, and an absorbent material 12 that is made of another type of material. Furthermore the absorbent material 12 may be fixed to the main section 20, or it may be releasably attached to the main section 20. In addition, the absorbent material 12 may be a polymer that allows flavoring previously absorbed by it to easily migrate and that also withstands high temperatures often experienced on a grill.

The main section 20 can be any desired shape to facilitate holding food. For example, in this and certain other embodiments, the main section 20 is substantially straight. In other embodiments, the main section 20 may curve, or include one or more sections that curve and one or more sections that are straight.

Still referring to FIG. 1, the skewer 10 is prepared for future use by adding the flavoring to the absorbent material 12. This may be accomplished under atmospheric conditions or under a different pressure. For example, in one embodiment the absorbent material 12 is immersed in the flavoring for a period of time. The amount of time spent immersed depends on how absorbent the absorbent material 12 is, the absorbent material's size, the ratio of the absorbent material's surface area 22 to the absorbent material's volume, and the type of flavoring. The larger the absorbent material 12, that is the greater its volume, then the longer the absorbent material 12 should remain immersed. The larger the ratio of the absorbent material's volume to the absorbent material's surface area, then the longer the absorbent material 12 should remain immersed. The slower the rate that the body 12 absorbs the flavoring, then the longer the absorbent material 12 should remain immersed. After the absorbent material 12 is immersed, the absorbent material 12 is dried for at least 4 hours, longer depending on the type of flavoring. Then, the absorbent material 12 is vacuum packed to help the material 12 retain the flavoring and preserve its freshness.

Other embodiments are possible. For example, the flavoring may be mounted to the surface 22 using any desired technique, such as an edible adhesive. Alternatively, the flavoring material may be dried or baked on to the surface 22.

Still referring to FIG. 1, the skewer 10 is prepared for cooking by soaking the skewer 10 in water for a period of time that depends on the size of the skewer 10 and how long the skewer 10 will be exposed to a cooking temperature. For example, in one embodiment the skewer 10 soaks in water for about 20 minutes. If the skewer 10 includes a thicker and/or wider cross-section, then the skewer should soak for more than 20 minutes. In addition, if the skewer 10 will be exposed to cooking temperatures for more than 10 minutes, then the skewer 10 should soak for more than 20 minutes.

FIG. 2 is a cross-sectional view of the skewer 10 in FIG. 1. FIG. 3 is a cross-sectional view of a skewer 24 according to another embodiment of the invention. As shown in FIGS. 2 and 3, a skewer can have any desired cross-sectional size and shape.

The size and shape of the absorbent material's cross-section 26 (here also the cross-section of the main section 20) helps determine the amount of flavoring that the absorbent material 12 can hold, the amount of time required for the flavoring to migrate to the surface 22, and the amount of flavoring that can be made available at the surface 22 for food to absorb. The size of the cross-section 26 (FIGS. 2 and 3) can be expressed as the area of the cross-section, and the shape of the cross-section includes the ratio of the cross-section's perimeter to the cross-section's area. The area of the cross-section determines the capacity of the absorbent material 12, that is, the amount of flavoring that the absorbent material can hold. A large area provides a large capacity, and a small area provides a small capacity. The ratio of the perimeter to the area affects the amount of time required for the flavoring to migrate to the perimeter, and thus suggests the amount time required to migrate to the surface 22 because the surface 22 is the sum of the respective perimeters of each cross-section taken along the length of the absorbent material 12. The ratio also affects the amount of flavoring available at the perimeter at a point in time (and thus surface 22 as previously explained). A high ratio means the cross-section 26 has a long perimeter relative to its area, which allows a large amount of flavoring to quickly be made available for food to absorb. A low ratio means the cross-section has a short perimeter relative to its area, which allows a small amount of flavoring to slowly be made available for food to absorb.

For example, in the embodiment shown in FIG. 2 and in certain other embodiments, the absorbent material 12 has a rectangular cross-section 26. In the embodiment shown in FIG. 2, the absorbent material 12 has a width of 7 mm and a thickness of 3 mm. Thus, the area of the cross section 26 is 21 mm², the perimeter is 20 mm and the ratio of the cross-section's perimeter to the cross-section's area is about 1. In this embodiment, the flavoring 28 is disposed through out the area of the cross-section. When meat held by the skewer 10 is cooked for about 7 minutes, the absorbent material 12 timely provides a sufficient amount of flavoring to the surface 22. In other embodiments, the cross-section can remain rectangular but have a ratio of its perimeter to its area that is greater than or less than 1.

In the embodiment shown in FIG. 3, the absorbent material 12 has a circular cross-section 30 and also forms the main section 32. The circular cross-section has a diameter of 10 mm, and thus, the area of the cross-section is about 78.5 mm², the perimeter is about 31.4 mm, and the ratio of the cross-section's perimeter to the cross-section's area is about 0.4. This size and shape may be desirable when cooking food for a longer period of time under reduced heat.

Other embodiments are possible. For example, the size and/or shape of the absorbent material's cross-sections can change as the location of the cross-section along the length of the absorbent material changes.

FIG. 4 is a perspective view of a section of the skewer 10 in FIG. 1. As discussed elsewhere herein, a wood's fibers 34 may be oriented relative to a region of the surface 22 to promote or hinder the migration of the flavoring toward the surface 22. In this manner, woods that do not allow essential oils to easily migrate within them may still be used as absorbent material 12, and woods that do allow essential oils to easily migrate within them may be used in applications that require slower migration.

Woods absorb fluids inside and outside of their fibers. Fluids absorbed inside the fibers are typically absorbed faster than fluids that are absorbed out side of the fibers. For example, when one applies stain to a wood's surface, some sections of the wood absorb more stain (the darker sections) than other sections of the wood (the lighter sections). The darker sections are where the stain has been absorbed inside the wood's fibers, and the lighter sections are where the stain has been absorbed outside of the wood's fibers. Thus, the surface of the darker section includes exposed cross-sections of the wood's fibers.

Similarly, one can affect the ease with which the flavoring migrates to the surface 22 of the absorbent material 12 by exposing the cross-section of some or many of the wood's fibers. For example, in this and certain other embodiments, the regions 36 of the surface 22 that contain exposed fibers 34 are the two larger sides of the rectangular cross-section. Furthermore, the fibers 34 densely populate (much of the fibers have been omitted for clarity) the regions 36, and are substantially perpendicular to the regions 36. In other embodiments, the fibers 34 may be angled relative to the region, and thus expose a larger cross-section of the fiber at the surface 22. In still other embodiments, the fiber density of the regions may be more or less. In still other embodiments, the fibers 34 may be exposed in other regions of the surface. These other regions may be in addition to the regions 36 or lieu of the regions 36.

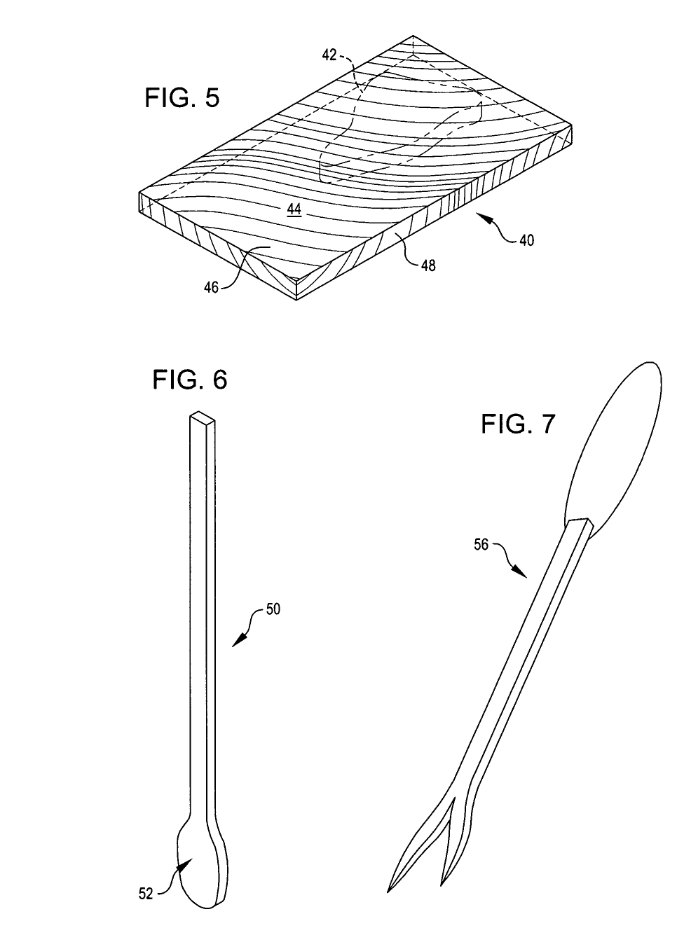

FIG. 5 is a perspective view of a plank 40 according to another embodiment of the invention. The plank 40 is similar to the skewers 10 and 24 (FIGS. 1-4) except that the food 42 (shown in phantom) is placed on the surface 44 while the food 42 and plank 40 cook. The plank 40 includes flavoring (not shown in FIG. 5) that has an essential oil to flavor the food 42 that it contacts. The plank 40 also supports the food while flavors of the food 42 and plank 40 combine to enhance the food's flavoring or to generate a different flavor. The plank 40 may support food while one cooks the food, or the plank may support food that will not be cooked before being eaten, such as fruit.

Because the plank 40 typically has a large volume and a small ratio of the area of the surface 44 to the volume, the food 42 and plank 40 are typically cooked for a longer period than the food and skewer combinations. Furthermore the plank 40 should be immersed in flavoring for a longer period of time than the skewers 10 and 24 to allow the absorbent material 46 of the plank 40 plenty of time to absorb flavoring. Likewise, to prepare the plank 22 for use, the plank should be soaked in water longer than the skewers 10 and 24; typically 1 hour.

In this and certain other embodiments, the plank 40 includes a body 48 having the absorbent material 46 which forms the body 48. Other embodiments are possible. For example, the plank 40 may include a body 48 made of a material, and an absorbent material 46 that is made of another material. Furthermore the absorbent material may be fixed to the body 48, or it may be releasably attached to the body 48. In addition, the absorbent material may be a polymer that allows flavoring previously absorbed by it to easily migrate and that also withstands high temperatures often experienced on a grill. In still other embodiments, the plank may be shaped like a circular dish or a bowl.

FIG. 6 is a perspective view of a swizzle stick 50 according to yet another embodiment of the invention. The swizzle stick 50 is similar to the skewers 10 and 24 except that one typically uses the swizzle stick 50 to stir a drink or liquefied food, such as soup or broth, and enhance or modify the drink's or food's flavor. The swizzle stick 50 includes flavoring (not shown in FIG. 6) that has an essential oil to flavor the drink or food that it contacts. In this and certain other embodiments, the swizzle stick 50 includes a spoon shaped region 52 to facilitate stirring.

Because the swizzle stick 50 is similar to the skewers 10 and 24, the swizzle stick 50 should be similarly prepared for future use. Because the swizzle stick is typically used to stir a drink, one does not have to soak the swizzle stick 24 in water before stirring a drink. However, If one uses the swizzle stick 24 to mix foods heated to a cooking temperature, then one may want to prepare the swizzle stick 24 for cooking in a manner similar to preparing the skewer 10.

FIG. 7 is a perspective view of a fondue stick 56 according to yet another embodiment of the invention. The fondue stick 56 is similar to the skewers 10 and 24 except that one uses the fondue stick 56 to hold food in a fondue pot (not shown), and to enhance or modify the food's flavor. The fondue stick 56 includes flavoring (not shown in FIG. 7) that has an essential oil to flavor the food that it contacts.

What is claimed is:

1. A skewer for flavoring food, the skewer comprising:
a body operable to impale food and including an absorbent material that has a surface that contacts the food when the body impales the food; and
flavoring that includes an essential oil, the flavoring being disposed in the absorbent material and migrating to the surface when the food is impaled by the body.

2. The skewer of claim 1 wherein the flavoring migrates to the surface when the body is heated.

3. The skewer of claim 1 wherein the flavoring migrates to the surface by capillary action.

4. The skewer of claim 1 wherein the flavoring includes an oleoresin.

5. The skewer of claim 1 wherein the absorbent material includes wood.

6. The skewer of claim 5 wherein the body is wood.

7. The skewer of claim 5 wherein:
the wood has a fiber, and
the surface includes a cross-section of the wood's fiber.

8. The skewer of claim 7 wherein a substantial area of the surface includes cross-sections of the wood's fibers.

9. The skewer of claim 5 wherein the wood is ash.

10. The skewer of claim 5 wherein the wood is birch.

11. The skewer of claim 1 wherein the body has a length and a cross-section taken perpendicular to the length that is substantially uniform with substantially all of the other cross-sections taken at other locations along the length.

12. The skewer of claim 11 wherein the cross-section is circular.

13. The skewer of claim 11 wherein cross-section is rectangular.

14. The skewer of claim 1 wherein the body is substantially straight.

15. The skewer of claim 1 wherein the food includes at least one of the following:
meat, vegetable and fruit.

16. A plank for flavoring food, the plank comprising:
a body operable to support food that is placed on the body and including an absorbent material that has a surface that contacts the food when the food is placed on the body; and
flavoring that includes an essential oil, the flavoring being disposed in the absorbent material and migrating to the surface when the food is placed on the surface.

17. The plank of claim 16 wherein the flavoring includes an oleoresin.

18. The plank of claim 16 wherein the absorbent material includes wood.

19. The plank of claim 18 wherein the body is wood.

20. The plank of claim 18 wherein:
the wood has a fiber, and
the surface includes a cross-section of the wood's fiber.

21. The plank of claim 20 wherein a substantial area of the surface includes cross-sections of the wood's fibers.

22. The plank of claim 18 wherein the wood is ash.

23. The plank of claim 18 wherein the wood is birch.

24. The plank of claim 16 wherein the body has a length and a cross-section taken perpendicular to the length that is substantially uniform with substantially all of the other cross-sections taken at other locations along the length.

25. A method for flavoring food, the method comprising:
absorbing flavoring into absorbent material of a skewer, the flavoring including an essential oil;
impaling the food with a body of the skewer;
contacting the food with a surface of the absorbent material; and
migrating the flavoring to the surface of the absorbent material.

26. The method of claim 25 wherein the absorbent material is wood having a fiber.

27. The method of claim 26 further comprising exposing a cross-section of the wood's fiber at the surface of the absorbent material.

28. The method of claim 25 wherein migrating the flavoring includes heating the food.

29. A method for flavoring food, the method comprising:
absorbing flavoring into absorbent material of a plank, the flavoring including an essential oil;
setting the food on a body of the plank;
contacting the food with a surface of the absorbent material; and
migrating the flavoring to the surface of the absorbent material.

30. The method of claim 25 wherein the absorbent material is wood having a fiber.

31. The method of claim 26 further comprising exposing a cross-section of the wood's fiber at the surface of the absorbent material.

32. The method of claim 25 wherein migrating the flavoring includes heating the food.
